(19) United States
(12) Patent Application Publication
(10) Pub. No.: US 2007/0155403 A1
(43) Pub. Date: Jul. 5, 2007

(54) Rogue Detection Using Geophysical Information

(75) Inventor: Donald M. Bishop, Highlands Ranch, CO (US)

Correspondence Address: MEDIACELL LICENSING CORP, 820 WELCH AVE, KRAJEC PATENT OFFICES, LLC, BERTHOUD, CO, 80513, US

(73) Assignee: MediaCell Licensing Corp, Centennial, CO (US)

(21) Appl. No.: 11/618,575

(22) Filed: Dec. 29, 2006

Related U.S. Application Data
(60) Provisional application No. 60/755,399, filed on Dec. 30, 2005.

(51) Int. Cl. H04Q 7/20

(52) U.S. Cl. 455/456.1

(57) ABSTRACT

Network devices have an internal or external geophysical location detection device that is used to verify the physical location of the network device. The physical location may be compared to the expected location of the device, the network connection point, or connection with neighboring devices to determine if the network device is permitted access to the network. In one embodiment, a geophysical location is stored in the memory of the device upon initial installation. When the device is attached to the network at a later time, the actual location is compared to the previous location or a list of permitted locations to ensure the device has not been moved without authorization. In a second embodiment, the expected location is determined by attempting to detect the device with another network device.

### CROSS REFERENCE TO RELATED APPLICATIONS

This application claims priority to and benefit of U.S. Provisional Patent Application Ser. No. 60/755,399 filed 30 Dec. 2005 by Donald M. Bishop entitled “Rogue Detection Using Geophysical Information”, which is hereby incorporated by reference for all it discloses and teaches.

### BACKGROUND OF THE INVENTION

Dispersed networks are becoming ubiquitous and in some cases blanket a subdivision, town, or city with wired or wireless voice and data coverage. In general, a network may consist of many different network devices, from amplifiers and routers to computers, wireless access points, and other content sources and destinations.

A network service provider may require authentication for a newly attached device to provide access to the network. In many cases, the authentication may be automated so that devices may automatically come on line after a power failure, maintenance event, or other situation. In many actual network deployments, the authentication provisions are quite weak and easily overcome by rogue devices that may connect to the network and operate on the network without permission.

### SUMMARY OF THE INVENTION

Network devices have an internal or external geophysical location detection device that is used to verify the physical location of the network device. The physical location may be compared to the expected location of the device, the network connection point, or connection with neighboring devices to determine if the network device is permitted access to the network. In one embodiment, a geophysical location is stored in the memory of the device upon initial installation. When the device is attached to the network at a later time, the actual location is compared to the previous location or a list of permitted locations to ensure the device has not been moved without authorization. In a second embodiment, the expected location is determined by attempting to detect the device with another network device.

### BRIEF DESCRIPTION OF THE DRAWINGS

In the drawings,

FIG. 1 is a diagrammatic illustration of an embodiment showing a wired network with attached wireless devices.

FIG. 2 is a diagrammatic illustration of an embodiment showing a network device with geophysical location information.

FIG. 3 is a flowchart illustration of an embodiment showing a method for detecting rogue devices on a network.

FIG. 4 is a flowchart illustration of an embodiment showing a method for detecting rogue devices on a network by using neighboring devices.

### DETAILED DESCRIPTION OF THE INVENTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the subject matter as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Throughout this specification, the term “comprising” shall be synonymous with “including,” “containing,” or “characterized by,” is inclusive or open-ended and does not exclude additional, unrecited elements or method steps. “Comprising” is a term of art which means that the named elements are essential, but other elements may be added and still form a construct within the scope of the statement. “Comprising” leaves open for the inclusion of unspecified ingredients even in major amounts.

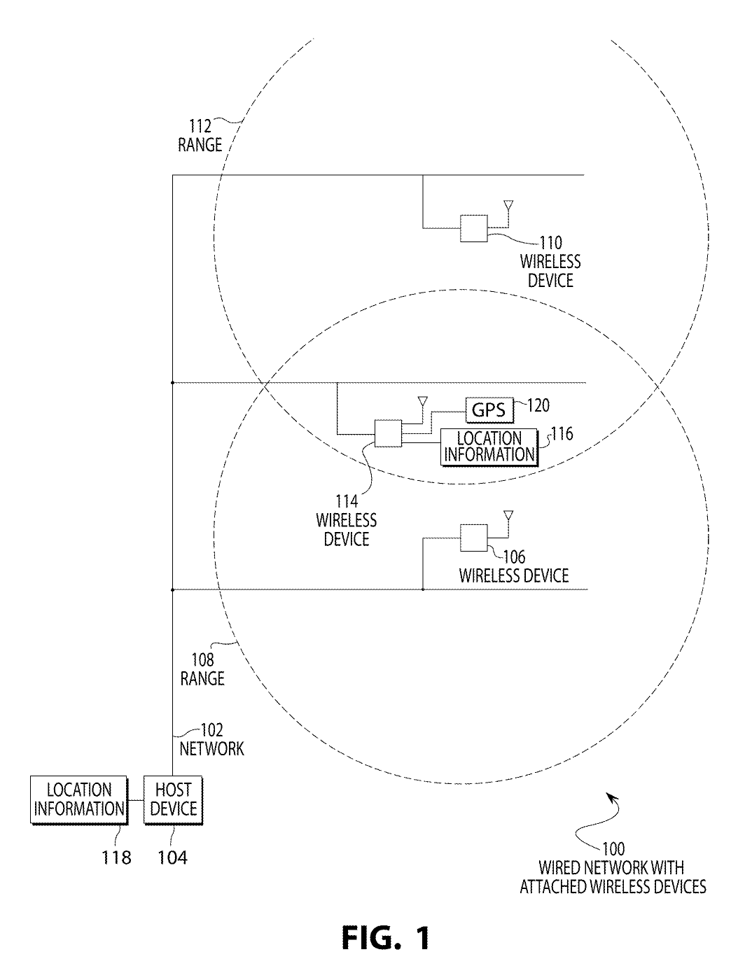

FIG. 1 illustrates an embodiment 100 showing a wired network with attached wireless devices. The network 102 has a host device 104 along with wireless device 106 having a range 108, and wireless device 110 with a range 112. The wireless device 114 has internal location information 116, which may also be stored at the host device 104 in a location information store 118. The wireless device 114 may have a global positioning system (GPS) 120.

The embodiment 100 shows a network that is capable of determining if the wireless device 114 is a rogue device. When the wireless device 114 comes online, the host device 104 may determine if the wireless device 114 is permitted access by determining the expected geophysical location and using one or both of the wireless devices 106 and 110 to detect if the wireless device 114 is present. If the device 114 is supposed to be in range of both the wireless devices 106 and 110, the device 114 may be considered properly installed. If the wireless device 114 is supposed to be connected to a different part of the network but is detected by wireless device 106 or 110, or if the internal GPS 120 determines that the device 114 is in a different location, the wireless device 114 may be considered a rogue device that is improperly connected to the network.

In another use of the embodiment 100, the wireless device 114 may have an installed location stored in the location information 116. The host device 104 or the internal controller in the wireless device 114 may compare the stored location information 116 with the actual location information from the GPS 120 or by triangulating with wireless devices 106 and 110 to determine the actual location of the device 114. The comparison may determine whether the device 114 is permitted access to the network or not. If the stored location 116 and actual location from the GPS 120 agree, the device may be assumed to be properly installed. If the locations are different, the device may have been stolen or moved without authorization.

In various embodiments, the expected location of the device 114 is compared to at least a rough determination of the actual location of the device 114 to determine if the device 114 may be a rogue device. When the device 114 is brought online and connects to the network, part of the authentication routine may include checking the physical location of the device. If the device 114 has been moved or relocated without authorization, the device 114 may be considered stolen and may be denied authorization to operate on the network 102.

The actual location of the device 114 may be determined through an internal GPS receiver 120 or by any other mechanism by which at least an approximate location for a device 114 may be determined. In some embodiments, the detection by devices 106 and 110 may be sufficient to triangulate the position of device 114. In other embodiments, the location of device 114 may be determined by the physical connection point of the device 114 to the network 102.

The device 114 may be any device connected to the network 102. The device 114 may be fixed mounted, such as a network router, computer, wireless access point, amplifier, relay, switch, or any other fixed mounted network device. The device 114 may also be any type of mobile network device, such as a radio transceiver.

The network 102 may be any type of wired or wireless network. For example, the network 102 may be a hybrid fiber-coaxial (HFC) network that is commonly used for cable television networks, or a twisted pair network commonly used for telephony. In the former case, the host device 104 may be a cable television headend, while in the latter case the host device 104 may be a digital subscriber line access module (DSLAM). The network topology may be any network topology.

The network 102 may be dispersed over a wide area that may comprise thousands of square miles or may be located within a building or campus. In some cases, the network 102 may span entire continents.

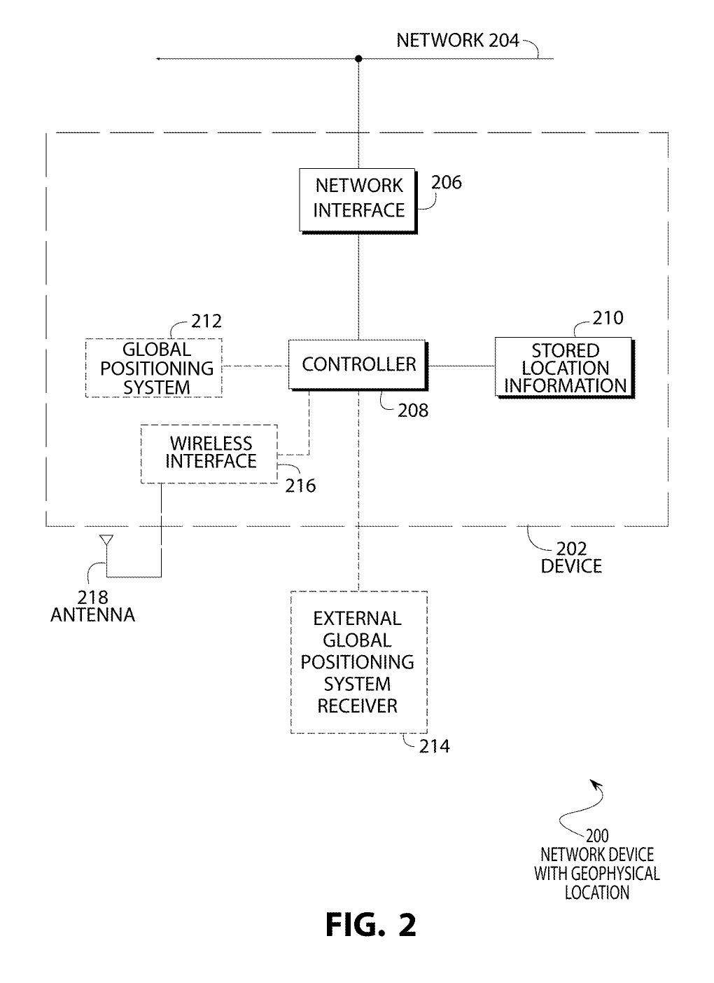

FIG. 2 is a diagrammatic illustration of an embodiment 200 showing a network device with geophysical location information. The device 202 is connected to a network 204 through a network interface 206. The controller 208 may access stored location information 210. In some embodiments, an internal global positioning system (GPS) receiver 212 may be present, while in others an external global positioning system receiver 214 may be temporarily attached during installation or maintenance. In some embodiments, the controller 208 may connect to a wireless interface 216 which is in turn connected to an antenna 218.

The embodiment 200 illustrates a fixed mounted network device that may have a built-in GPS 212 or other mechanism for determining the geophysical location of the device 202. Among other uses for a GPS receiver in a fixed mounted device, the actual location of the device may be used for rogue detection. When a device is stolen or when unauthorized devices are used to gain access to a network 204, the actual location of the device may be used in conjunction with other mechanisms to determine if the device should be authorized to access the network 204.

At least two other mechanisms may be used to determine whether a device is a rogue device. In one case, the expected location of the device may be confirmed by a neighboring device which may have a known geophysical location. In another case, the actual location may be determined by an internal geophysical location detection system, which may include a GPS receiver or other device capable of determining the physical location of a device.

The wireless interface 216 may a primary function of the device 202, such as for a network wireless access point. In other embodiments, the wireless interface 216 may be used primarily for determining the geophysical location with respect to other devices either on the network 204 or for determining the same with respect to other devices outside the network 204.

The external global positioning system receiver 214 may be handheld or other portable GPS receiver that may be used by an installing technician to load location coordinates into the stored location information 210. The contents of the stored location information 210 may be stored in a non-volatile memory location so that the stored location information 210 may be queried when a device has the power cycled.

In another embodiment, the stored location information 210 may be a volatile memory location. In such an embodiment, the location information 210 may be erased when the device 202 is disconnected and moved. When the location information 210 is not present, the device 202 may require an administrator, maintenance technician, or other authority to approve the device 202 for operation on the network 204.

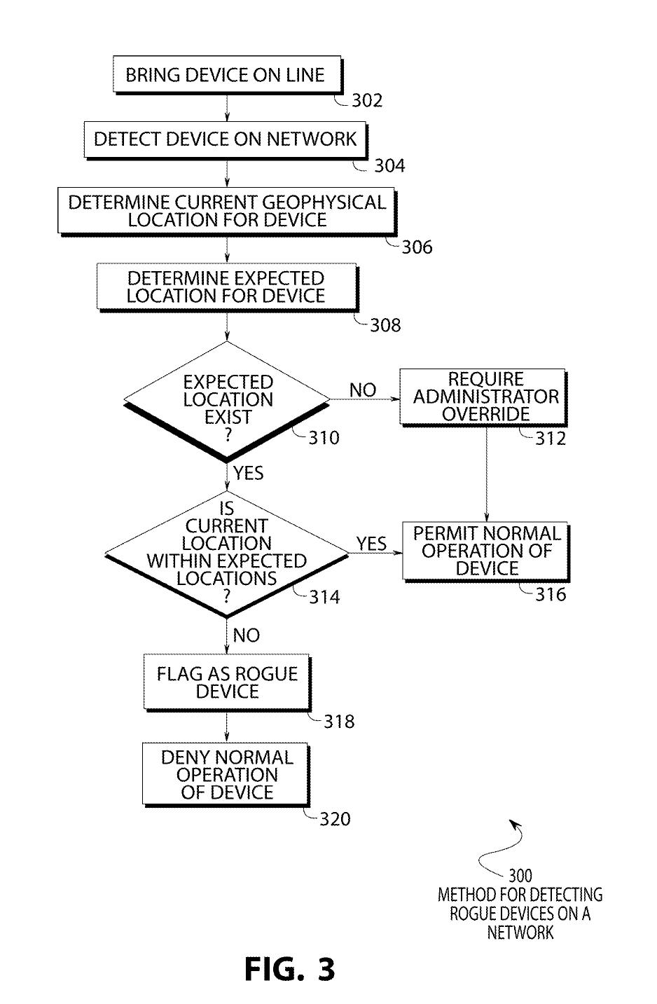

FIG. 3 is a flowchart illustration of an embodiment 300 of a method for detecting rogue devices on a network. The device is brought online in block 302 and detected on the network in block 304. The current geophysical location of the device is determined in block 306. The expected location for the device is determined in block 308. If no expected location exists in block 310, an administrator may be required to approve the installation of the device in block 312 and normal operation of the device may proceed in block 316. If the expected location does exist in block 310 and the current location is within the area of the expected locations in block 314, normal operation of the device may proceed in block 316. If the actual location of the device is outside the expected location in block 314, the device is flagged as a rogue device in block 318 and normal operation of the device is denied in block 320.

The embodiment 300 illustrates a method for using the actual location of a network device to verify that it is authorized to operate on a network. The method may be used for fixed mounted devices in a widely dispersed network, especially where the fixed mounted devices are prone to theft or may permit unauthorized access to the network. In particular, fixed mounted wireless access points that provide wireless connectivity to a wired network may be suited for such an embodiment.

The embodiment 300 requires that the actual location of a device on the network may be within an expected area for the device to be authenticated. The expected area may be the entire coverage area of a service provider's network or may be a very small area that defines a single installation point. In some embodiments where the expected area is very large, a network operator or service provider may use the authentication method to keep out devices that were used on another service provider's network in another geographic location. In embodiments where the expected are is very small, the network operator may wish to verify that each network device is in the one specific location assigned for that device.

In some embodiments, the tolerance of the current geophysical location in block 306 may be quite large. For example, one method for determining the location of a device is to use triangulation between one, two, or more external devices to determine a location of an unknown device. Such an example may be able to determine that a device is within an area that may be several hundred square yards to several square miles large, depending on the technologies and methods used for triangulation. In other embodiments, a global positioning system receiver may be used to verify location within several square feet.

The expected location of the device may be stored in the device itself or may be stored in a database on a host device or other device on or off the network. In embodiments where the expected location is stored in a host device, the host device may perform the authentication routine that establishes a connection with a newly added device to the network. The device may have a unique embedded electronic identification that is used by the host device to identify the device in a database of expected locations for a device.

In some embodiments, a host device may contain several expected locations for a specific device. In one embodiment, a host device may contain specific locations for all devices of a specific type as expected locations for that type of device. For example, the locations of all installed wireless connection points to a hardwired network may be stored in a host device database, which would permit any of the network's wireless connection points to be installed in any of the known locations. This would allow a maintenance technician to swap out one device for another without having an authentication problem. However, the embodiment may exclude a rogue device that is installed in an unauthorized location or an unauthorized device that was installed in a permitted location.

The device may be any type of device attached to a network. The devices may perform network operational functions, such as routers, switches, amplifiers, wireless connection points, or other such devices. The devices may also be content providing or requesting devices, such as monitoring devices, laptop or desktop computers located on the network, subscriber interface devices, data storage and retrieval devices, server computers, or any other device that provides or consumes data traffic on the network.

When a device is flagged as a rogue device and denied service in blocks 318 and 320, the device may be completely denied access to the network, it may be given limited access to the network, or it may be monitored as a suspicious device on the network. Various embodiments may handle rogue devices in various other manners as well.

In some embodiments, the rogue device may be given full access to the network but may be monitored by network administrators or surveillance software for suspicious activities. The monitoring activities may be clandestine so that the user of the rogue device is not aware of the monitoring. In some cases, maintenance personnel or security personnel may be dispatched to the location of the device to verify that the device is being used by authorized personnel.

In other embodiments, the rogue device may be given partial access to the network. The partial access may require that a user attached to the device or a technician installing the device enter appropriate credentials or execute additional maintenance routines in order to permit the device to have full access to the network. In some embodiments, a user may have to enter a credit card or otherwise subscribe to a service agreement for the rogue device to be fully activated. In other embodiments, a maintenance technician may have to add the new device and location to the database of permitted devices and locations. In still other embodiments, an administrator may be permitted to override the rogue flag and permit the device full access to the network.

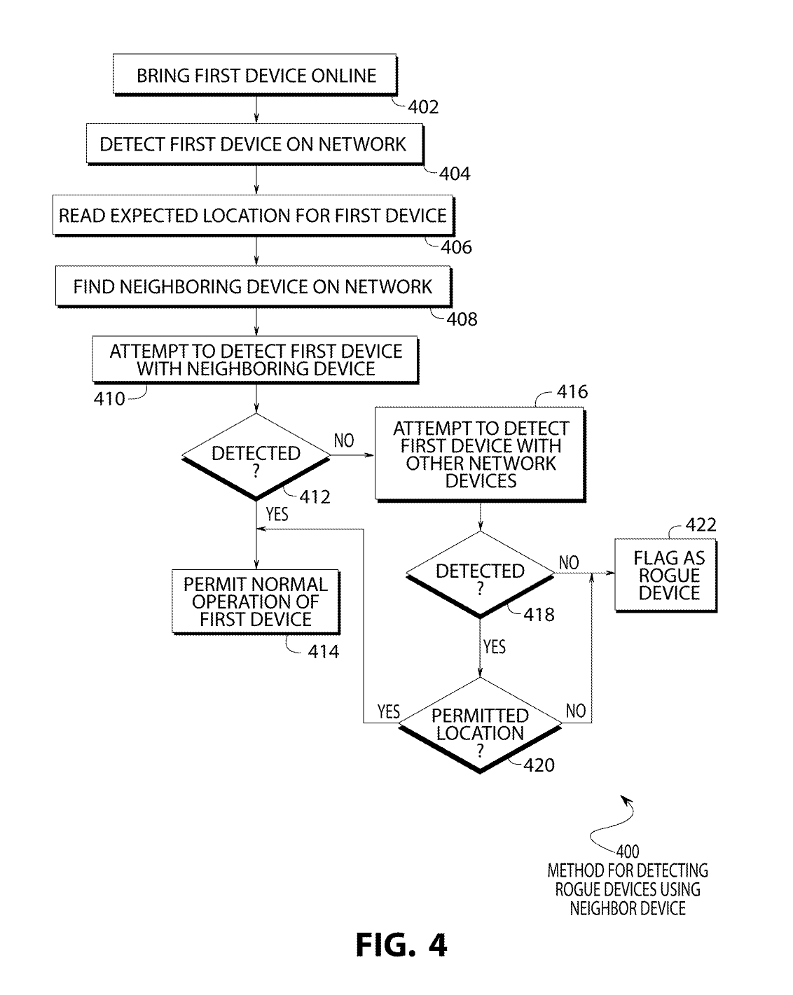

FIG. 4 is a flowchart illustration of an embodiment 400 showing a method for detecting rogue devices using a neighboring device. The device is brought online in block 402 and detected on the network in block 404. The expected location is determined in block 406 and a neighboring device is located in block 408, based on the expected location. The neighboring device is used to detect the presence of the first device in block 410. If the device is detected in block 412, the device is permitted normal operation in block 414. If the device is not detected in block 412, attempts may be made to detect the first device with other devices on the network in block 416. If the other devices detect the first device in block 418, and the first device is in an alternative but permitted location in block 420, the first device is permitted normal operation in block 414. If the first device is either not detected in block 418 or not within a permitted location in block 420, the first device is flagged as a rogue device in block 422.

The embodiment 400 uses a neighboring device to detect the presence of the newly added device to the network. When the neighboring device detects the first device, the location of the first device is verified and access may be permitted. If the first device is not detected, the location is unknown and the first device may be considered rogue.

The embodiment 400 may be useful in a network having wireless access points, where a neighboring wireless access point may be used to detect a newly added wireless access point. The various wireless access points may be connected by a hardwired network, but may also be able to communicate wirelessly. In some situations, the wireless access points may be capable of detecting the presence of a neighboring device but may not be capable of extensive two-way communication between them.

In some embodiments, a neighboring device may detect a signal broadcast from the first device. In other embodiments, the first device may detect a signal broadcast from the neighboring device. In either event, the transmittal and reception of a broadcast message between the two devices may be sufficient to determine that the devices are within relative proximity to each other.

In some embodiments, the various devices may be instructed in block 410 to transmit special messages that contain location or other identification information that may be used to determine location of one or more of the network devices. For example, wireless network devices may be instructed to transmit location coordinates or network device identification codes in broadcast messages that may be passively received by the first device. In another embodiment, the first device may be instructed to actively transmit a broadcast message comprising a unique identifier for the first device. Some embodiments may use beacon signals or other standard transmissions in a normal operating mode that contain such identifiers and may not necessarily transmit special messages in block 410 to determine the location of the first device.

Some embodiments may use broadcast radio signals transmitted from one device to another to detect the presence and relative location of one or both devices. In other embodiments, signals may be sent along the network connection. For example, devices connected on a hardwired network connection may be able to detect the physical presence or distance to another device by measuring the time delay in sending a signal to an unknown device. By knowing the network connection topology in relation to the physical location of the sending or receiving devices, a measurement of distance from a known location of a one device to an unknown location of a second device may be approximated. Using several distance measurements along a network connection to an unknown device from several known devices may enable triangulation of the unknown device location.

In other embodiments, two or more neighboring devices may be used to determine the position of the first device. As two or more devices are used, the location of the newly added device may be determined with more precision through triangulation.

Neighboring devices may be selected by a host device or other device that is capable of determining the geophysical location of neighboring devices. A database of the geophysical location of the devices may be referenced to determine which devices are neighboring. The neighboring devices may be sent a command to broadcast a specific message intended for the first device, or may receive a broadcast message from the newly added device and transfer the message to a host device.

In some cases, the various devices on the network may have internally stored location information. A broadcast message sent to many network devices may instruct those devices within a predefined area to perform various routines to attempt to detect a newly added device. A device that receives the broadcast message may be independently capable of determining whether or not it is within the boundary and perform the specified action.

In some embodiments, the newly added device may broadcast a special message that is received by whatever device is located nearby. The receiving device may relay the message to a host device without having to be specifically commanded to do so. The identity of the receiving device may be used to determine at least and approximate geophysical location of the newly added device.

The neighboring devices may be devices attached to the same network or may be other devices, such as cell phone towers, television or radio broadcast locations, or any other device that may have a known location when transmitting a signal received by the newly added device.

In some embodiments, an unknown device may be located by any device attached to the network. For example, if a wireless device is attached to a network backbone and begins to transmit, neighboring devices may be able to detect the device and determine the approximate location for the device. In another example, a wireless device may passively receive broadcast signals from one or more network devices and determine its approximate coordinates.

The newly added network device may be in a permitted location but may not be in the primary location set for that device. Embodiment 400 illustrates a method by which the primary location of the device is used to alert neighboring devices to detect the newly added device. When the detection fails, other devices on the network may be used to detect the presence of the first device in a passive or active mode. If the new location is still within the permitted locations for the device, the device is made active. If not, it is handled as a rogue device.

The foregoing description of the subject matter has been presented for purposes of illustration and description. It is not intended to be exhaustive or to limit the invention to the precise form disclosed, and other modifications and variations may be possible in light of the above teachings. The embodiment was chosen and described in order to best explain the underlying principles and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method comprising:
detecting a first device on a network;
determining a first geophysical location for said first device;
determining a first expected geophysical location for said first device;
comparing said first geophysical location with said first expected geophysical location; and
permitting said first device to operate on said network based on said comparing.

2. The method of claim 1 wherein said network comprises a wired connection.

3. The method of claim 1 wherein said network comprises a wireless connection.

4. The method of claim 3 wherein said wireless connection comprises a wireless network backbone.

5. The method of claim 3 wherein said wireless connection comprises a wireless connection to downstream devices.

6. The method of claim 1 wherein said first device comprises a wired connection and a wireless connection.

7. The method of claim 1 wherein said first geophysical location is based on a geophysical detection system internal to said first device.

8. The method of claim 7 wherein said geophysical detection system comprises a Global Positioning System receiver.

9. A host device comprising:
a network connection;
a controller adapted to:
detect a first device on a network;
determine a first geophysical location for said first device;
determine a first expected geophysical location for said first device;
compare said first geophysical location with said first expected geophysical location; and
permit said first device to operate on said network based on said comparing.

10. The host device of claim 9 wherein said network comprises a wired connection.

11. The host device of claim 9 wherein said network comprises a wireless connection.

12. The host device of claim 11 wherein said wireless connection comprises a wireless network backbone.

13. The host device of claim 11 wherein said wireless connection comprises a wireless connection to downstream devices.

14. The host device of claim 9 wherein said first device comprises a wired connection and a wireless connection.

15. The host device of claim 9 wherein said first device is fixedly mounted.

16. The host device of claim 9 wherein said first device is a mobile device.

17. The host device of claim 9 wherein said first geophysical location is based on a geophysical detection system internal to said first device.

18. The host device of claim 17 wherein said geophysical detection system comprises a Global Positioning System receiver.

19. The host device of claim 17 wherein said geophysical detection system is adapted to us a method comprising triangulation.

20. The host device of claim 9 wherein said first geophysical location is based at least in part by detecting said first device by a second device on said network.
